(19) United States
(12) Patent Application Publication
(10) Pub. No.: US 2002/0121406 A1
(43) Pub. Date: Sep. 5, 2002

(54) Safe tree step

(76) Inventor: William Thomas Summers, Hartford, WI (US)

Correspondence Address: Mr. William Thomas Summers, 6885 County Hwy Q, Hartford, WI, 53027, US

(21) Appl. No.: 10/083,915

(22) Filed: Feb. 27, 2002

Related U.S. Application Data
(60) Provisional application No. 60/273,013, filed on Mar. 5, 2001.

(51) Int. Cl. E06C 9/00

(52) U.S. Cl. 182/92

(57) ABSTRACT

A hunter's tree step including an integral loop is disclosed. The loop provides for the use by readily-available safety equipment.

### RELATED APPLICATION

This application claims priority from prior-filed provisional application Ser. No. 60/273013 filed Mar. 5, 2001.

### BACKGROUND OF THE INVENTION

This invention relates to steps which are attached to a tree or other vertical object such as a telephone pole, usable both as manual climbing aids and as safety equipment attachment points.

In hunting, especially bow hunting, it is desireable to have means to facilitate climbing a tree. Various devices have been known in the prior art, and generally consist of some small step arrangement which is screwed into or otherwise attached to the tree.

Rock-climbing has gained popularity as a recreational sport in recent years, and this sport has generated the proliferation and low cost of various safety systems to avoid falls while climbing. A ‘lanyard’ or safety belt is a common component of such a safety system; it is attached to ropes or static points with ‘carabiners’ which quickly and easily lock the climber to the safety point.

Carabiners are known in the prior art, as disclosed for example in U.S. Pat. Nos. 5,463,789, or 5,416,955. Lanyards are disclosed, for example, in U.S. Pat. No. 5,758,743.

Hunters often wait for long periods waiting for prey, and since silence is required, drifting to sleep and falling is a grave danger to hunters. There is a need for the popular equipment of rock-climbing to be adaptable to hunters to avoid falls.

Desirable features of a tree step are that it be inexpensive, reliable, and light in weight. Additionally, it should preferably be readily removable from the tree, either temporarily or permanently, and have features adaptable to popular climbing equipment. The tree step should be easy for the untrained person to use, and present minimal additional safety hazards.

Prior art tree steps do not address the safety objectives of the present invention. Prior art tree steps may be found in U.S. Pat. No. 5,624,007 to Mchaffy; U.S. Pat. No. 5,086873 to George; U.S. Pat. No. 4,669,575 to Skyba; U.S. Pat. No. 4,775,030 to Wright; U.S. Pat. Nos. 4,449612 and 4,620,610 to Southard; U.S. Pat. No. 4,700,807 to Kubiak; and U.S. Pat. No. 4,697,669 to Bergsten.

### SUMMARY OF THE INVENTION

It is an object of the present invention to provide a tree step which is simple in construction, reliable, and simple and inexpensive to manufacture, and provides for the use of safety equipment.

### BRIEF DESCRIPTION OF THE DRAWINGS

The preferred embodiment of the invention will now be described by way of example only, with reference to the accompanying drawings, in which:

FIG. 1 is a left perspective view of the tree step;

FIG. 2 is a right perspective view of the tree step emphasizing the cylindrical nature of the construction;

FIG. 3 is a side view;

FIG. 4 is a top view;

FIG. 5 shows the conventional wearing of a lanyard;

FIG. 6 shows a conventional carabiner; and

FIG. 7 shows a tree-climber utilizing the present invention.

### DETAILED DESCRIPTION OF THE PREFERRED EMBODIMENT

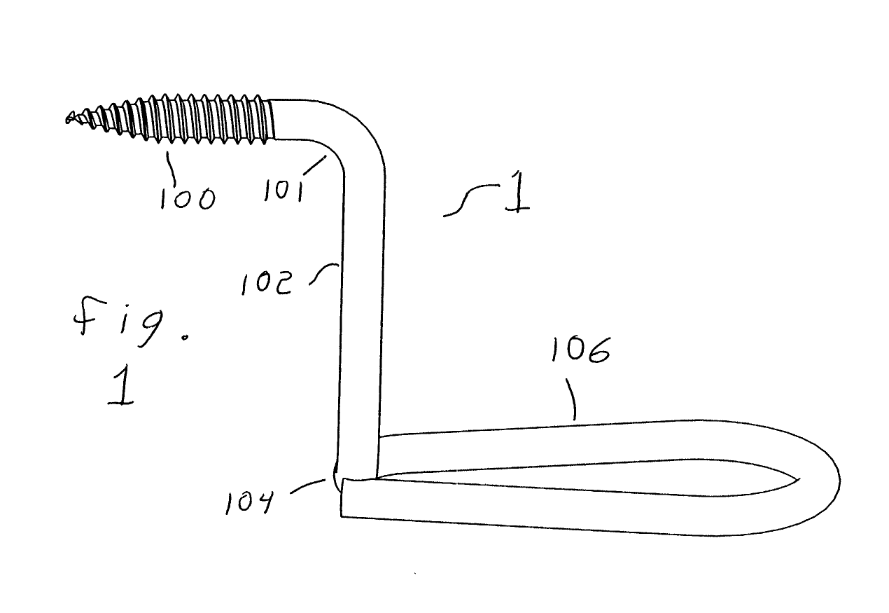

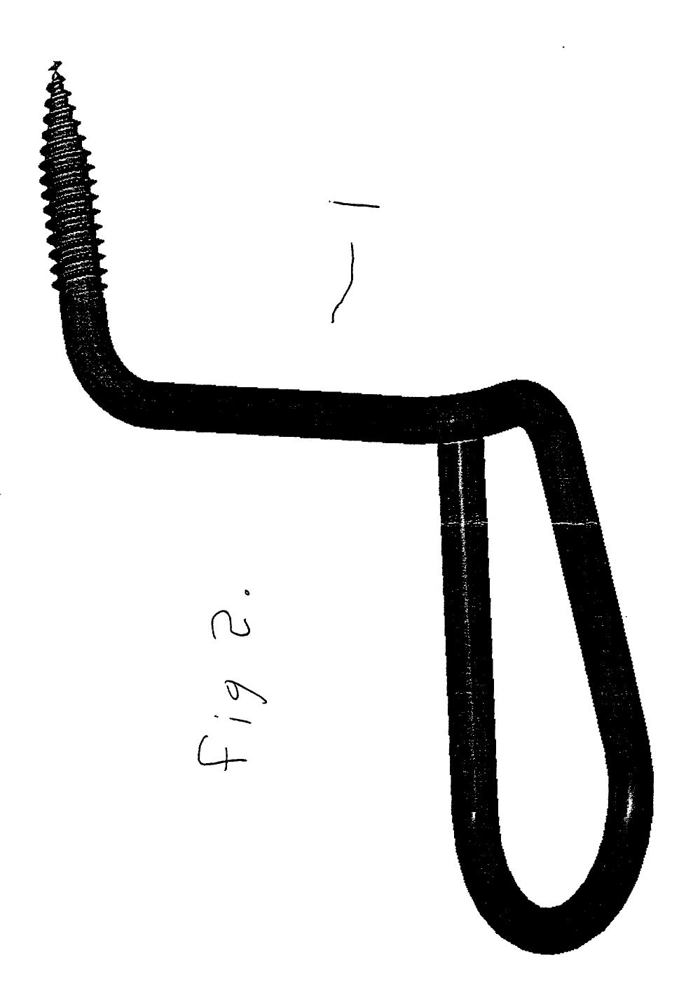

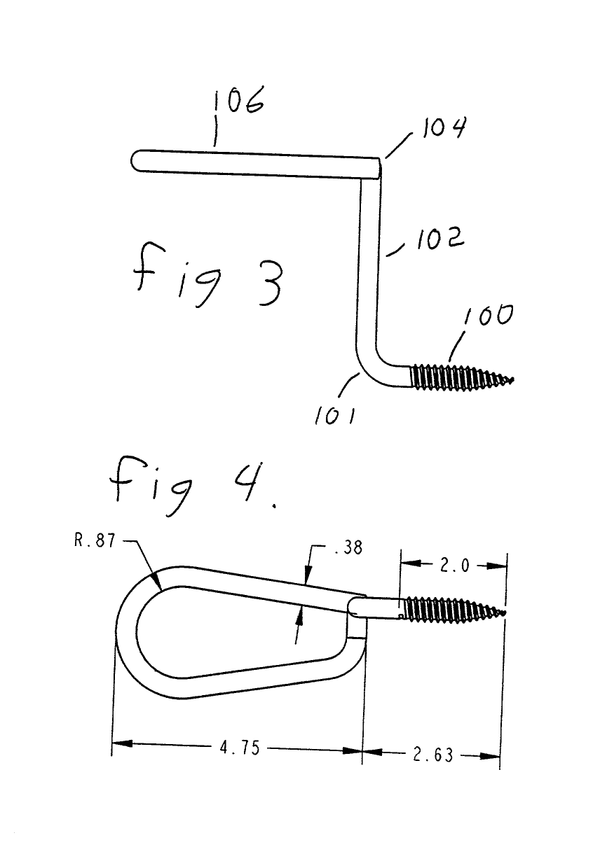

Referring to FIG. 1, the present invention is a tree step 1 preferably formed from a rod of steel or similar material, upon which tapered threads 100 are formed on one end. A downward bend 101 is made to form a drop or lever 102, and another bend 104 is made such that the rod is again bent to be horizontal. A loop 106 brings the other end of the rod back to a point near the bend 104.

The step is screwed into a tree by gripping the loop 106 and turning the loop 106 about the lever 102 so that the threads 100 are forced into the tree. If further force is required, as for example if a knot is struck in the wood, another step 1 may be placed inside loop 106 for increased leverage. When sufficient threads have penetrated the wood, turning is stopped when loop 106 is downward. The loop 106 is usable for three purposes:

1. As a handhold;

2. As a footstep; or

3. As a loop for connecting carabiners or other safety equipment.

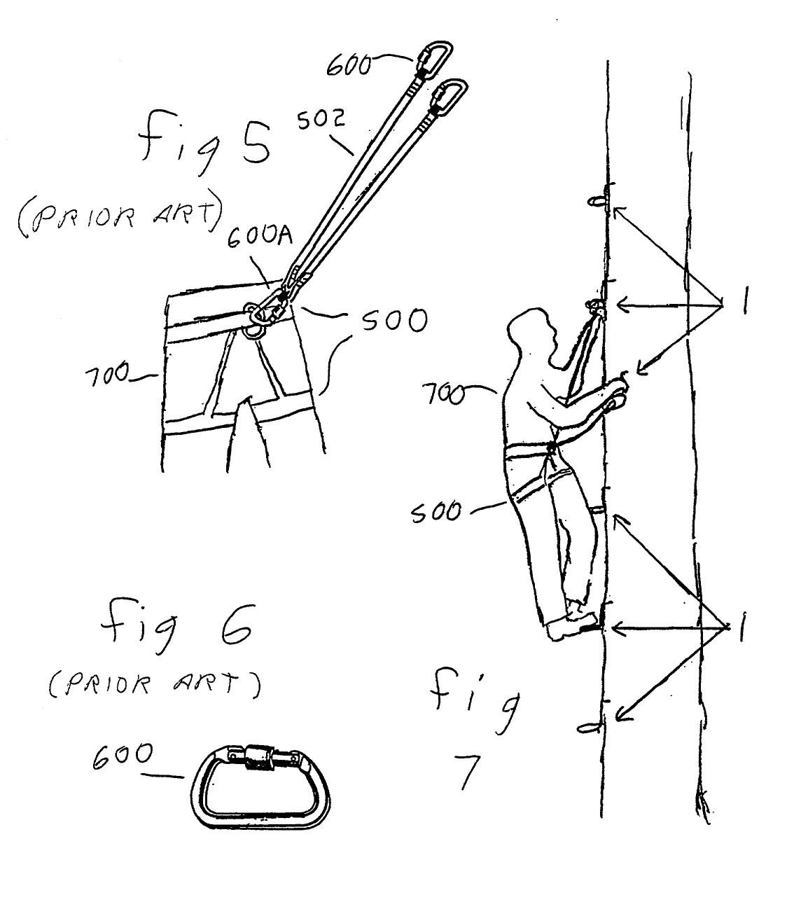

Referring to FIG. 4, the loop 106 is several inches wide, providing a safe and comfortable step, as well as a reliable clip point for a carabiner 600 as shown in FIG. 6. Carabiners are used as shown in FIG. 5; Carabiner 600A holds ropes 502 to a lanyard 500 worn by a person 700. Carabiners 600 are used as shown in FIG. 7; a person 700 wearing a lanyard 500 is using his left hand to clip a carabiner 600 onto the loop of tree step 1, while his right hand is holding onto another tree step 1 which already has a rope and carabiner attached. The left and right ropes are alternatively moved, so that one rope is always attached to break a fall. The climber's weight is on his right foot, being supported by another tree step 1.

Unlike some other prior art tree steps, the protruding portion of the present invention is rounded rather than sharp, reducing the chance of impaling and injuring a hunter who slips. The loop construction also provides no possibility for safety equipment to merely slide off. The loop is wider, providing a safer and more comfortable footstep. The loop is furthermore easier to grip by hand.

The above description relates to the preferred embodiment by way of example only. Many obvious variations on the invention would be apparent, and such obvious variations are considered to be within the scope of the invention, whether or not expressly described and claimed herein. For example, the step is disclosed as made of steel, but any material strong enough for the purpose could be used. The loop is shown as rounded, but any shape capable of the intended purpose could be used.

What is claimed is:

1. A step for climbing, comprising:
a screw;
a lever connected at substantially a right angle to the screw;
and a loop connected to the lever, at an angle substantially parallel to the screw, said loop being of sufficient size to perform as a tree step, handhold, or lanyard clip.

2. A step for climbing, consisting of:
A single metal rod, worked to form
a screw;
a lever connected at substantially a right angle to the screw;
and a loop connected to the lever, at an angle substantially parallel to the screw, said loop being of sufficient size to perform as a step, handhold, or lanyard clip.
